(19) United States
(12) Patent Application Publication
(10) Pub. No.: US 2008/0158435 A1
(43) Pub. Date: Jul. 3, 2008

(54) Remote control posittioning system

(75) Inventor: Wen-Ping Yu, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: AmTRAN TECHNOLOGY CO., LTD., Taipei (TW)

(21) Appl. No.: 11/716,193

(22) Filed: Mar. 9, 2007

(30) Foreign Application Priority Data
Dec. 27, 2006 (TW) 095149340

(51) Int. Cl. H04N 5/44

(52) U.S. Cl. 348/734; 348/E05.001

(57) ABSTRACT

A remote control positioning system adopting radio frequency (RF) positioning technology and displaying positioning information of the remote control on a display is provided. When a user is searching for the remote control, the remote control positioning system can be used to obtain the positioning information from a screen of the display, and the user can rapidly determine a position of the remote control according to environment images captured by an image capturing module. Thus, the time for searching by the user is saved, and an effect of precise tracking is realized as well.

### CROSS-REFERENCE TO RELATED APPLICATIONS

This non-provisional application claims priority under 35 U.S.C. § 119(a) on Patent Application No(s). 095149340 filed in Taiwan, R.O.C. on Dec. 27, 2006, the entire contents of which are hereby incorporated by reference.

### BACKGROUND OF THE INVENTION

1. Field of Invention

The present invention relates to a remote control positioning system, and more particularly, to a remote control positioning system adopting radio frequency (RF) technology.

2. Related Art

With the popularity of wireless communication technology, almost all modern home appliances, such as TVs, audio systems, DVD players, or air conditioners, are provided with remote controls with various manipulation functions. However, a user may have many remote controls and often leave the remote controls lying around. When a certain remote control is needed, the user often cannot find it.

In view of the above, the industry has developed many solutions. For example, Taiwan Patent Publication No. 00373766 entitled “Home Appliance Remote Control with Searching Device” uses a transmitter to generate an audio signal, and a corresponding audio receiver on the remote control to generate a beep in response, and thus the remote control can be found. In addition, for example, Taiwan Patent Application No. 093211062 entitled “Remote Control Tracking Device” uses a signal receiving apparatus connected to an alarm device in the remote control, and uses a signal transmitting apparatus installed on a home appliance to transmit a signal, such that the remote control gives an alarm of light and beep, and thus the remote control can be found.

However, the above two inventions have limitation in searching distances, and become ineffective if covered by a shielding in the environment. In addition, when the remote controls are placed in closed spaces such as drawers or cabinets, it is difficult to perceive the light and sound alarms produced by the remote controls. Therefore, the tracking effects of the above two inventions are greatly limited.

### SUMMARY OF THE INVENTION

In view of the problems when a user is searching for a remote control according to the prior art, the present invention provides a remote control positioning system, which adopts RF technology and uses a display to display positioning information of the remote control, so as to help a user find a position of the remote control rapidly.

In one embodiment, the remote control positioning system disclosed in the present invention includes a signal transmitting module, a wireless transceiving module, at least three wireless access points, and a signal processing module.

The signal transmitting module is electrically connected to a display for transmitting a first sensing signal, and includes a transmitter for transmitting the first sensing signal and a starting module electrically connected to the transmitter for starting the transmitter. The wireless transceiving module is installed on the remote control, for sending a second sensing signal upon receiving the first sensing signal. The at least three access points are arranged at different non-collinear positions in an indoor environment, and the wireless access points transmits a first detecting signal and a second detecting signal after receiving the first sensing signal and the second sensing signal respectively. The signal processing module is electrically connected to the display, for receiving the first and second detecting signals and generating the positioning signal, and the signal processing module includes a receiver for receiving the first and second detecting signals and a CPU electrically connected to the receiver for operating and processing the first and second detecting signals to generate the positioning information through a positioning mode.

In another embodiment, the remote control positioning system disclosed in the present invention includes a signal transmitting module, an image capturing module, a wireless transceiving module, at least three wireless access points, and a signal processing module.

The signal transmitting module is electrically connected to a display for transmitting a first sensing signal, and includes a transmitter for transmitting the first sensing signal and a starting module electrically connected to the transmitter for starting the transmitter. The image capturing module is installed on the remote control, for capturing an external image and converting the captured image into a wireless data signal. The wireless transceiving module is electrically connected to the image capturing module, for starting the image capturing module to capture the image upon receiving the first sensing signal, and sending a second sensing signal and transmitting the wireless data signal simultaneously. The at least three wireless access points are arranged at different non-collinear positions in an indoor environment, and the wireless access points transmit a first detecting signal and a second detecting signal after the first sensing signal and the second sensing signal are received respectively. The signal processing module is electrically connected to the display, for receiving the wireless data signal and the first and second detecting signals and generating the positioning information, and the signal processing module includes a receiver for receiving the first and second detecting signals and a CPU electrically connected to the receiver for operating and processing the first and second detecting signals to generate positioning information through the positioning mode.

The remote control positioning system disclosed in the present invention adopts the RF positioning technology to expand the tracking and positioning area, such that the positioning of the remote control is not limited by the distance or landscape. Furthermore, the positioning information on a screen of the display precisely indicates the relative distance and relative position between the remote control and a reference position, so the user can rapidly find the position of the remote control. Moreover, by displaying the captured environment image of the remote control by means of a sub-picture, the user can effectively determine the position of the remote control intuitively, such that the user can find the remote control conveniently.

Detailed features and examples of the present invention are described in the embodiments below with reference to the accompanying drawings, and their content is adequate for persons skilled in the art to understand the technical content of the present invention and to implement the present invention. According to the content and drawings disclosed in the specification, persons skilled in the art can easily understand the objectives and advantages of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a simplified block diagram of a remote control positioning system according to a first embodiment of the present invention;

FIG. 2 is a schematic block diagram of the signal transmitting module of the remote control positioning system according to the first embodiment of the present invention;

FIG. 3 is a schematic block diagram of the signal processing module of the remote control positioning system according to the first embodiment of the present invention;

FIG. 4 shows an implementation aspect of the remote control positioning system according to the first embodiment of the present invention;

FIG. 5 shows a display picture of an implementation aspect of the remote control positioning system according to the first embodiment of the present invention;

FIG. 6 is a simplified block diagram of the remote control positioning system according to a second embodiment of the present invention; and

FIG. 7 shows a display picture of an implementation aspect of the remote control positioning system according to the second embodiment of the present invention.

### DETAILED DESCRIPTION OF THE INVENTION

To make the objectives, structure, features and function of the present invention more understandable, the present invention is illustrated below in detail with reference to the embodiments. The description on the content of the present invention above and the description on the embodiments below are used to exemplify and explain the principle of the present invention, and provide further explanation on the claims of the present invention.

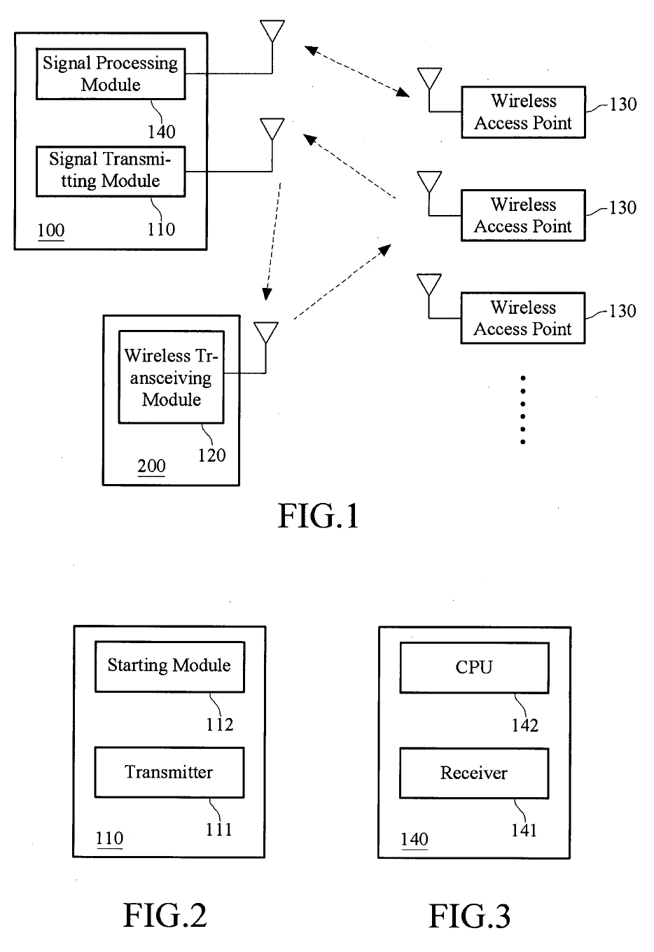

FIG. 1 is a simplified block diagram of a remote control positioning system according to a first embodiment of the present invention. Referring to FIG. 1, the system architecture of the present invention will be described below in detail.

As shown in FIG. 1, the remote control positioning system of the present invention can display positioning information of a remote control 200 with a display 100 in an indoor environment through RF positioning technology, so as to help the user to find the position of the remote control. The remote control positioning system includes a signal transmitting module 110, a wireless transceiving module 120, at least three wireless access points 130, and a signal processing module 140.

The signal transmitting module 110 is electrically connected to the display 100 for transmitting a first sensing signal to the wireless transceiving module 120 and the wireless access points 130. As shown in FIG. 2, the signal transmitting module 110 includes a transmitter 111 and a starting module 112. The transmitter 111 is used for transmitting the first sensing signal, and the starting module 112 is electrically connected to the transmitter 111, and serves as a touch switch of the transmitter 111. The starting module 112 can be a key module (a key 410 as shown in FIG. 5) or a touch panel (not shown) installed on the display 100, and provides a trigger function to positioning and searching when a user needs to search for the remote control 200.

The wireless transceiving module 120 is installed on the remote control 200, for transmitting a second sensing signal to the wireless access points 130 upon receiving the first sensing signal transmitted by the signal transmitting module 110.

The wireless access points 130 are arranged at different non-collinear positions in an indoor environment, for transmitting a first detecting signal to the signal processing module 140 after the first sensing signal transmitted by the signal transmitting module 110 is received, and transmitting a second detecting signal to the signal processing module 140 after the second sensing signal transmitted by the wireless transceiving module 120 is received. Here, at least three wireless access points 130 are required for providing effective positioning operation on the basis of triangulation principle.

The signal processing module 140 is electrically connected to the display 100, for receiving the first and second detecting signals, and operating and generating the positioning information through a positioning mode. The signal processing module 140 can be a built-in functional block of the display 100 or an external electronic device. Furthermore, as shown in FIG. 3, the signal processing module 140 includes a receiver 141 and a CPU 142. The receiver 141 is used for receiving the first and second detecting signals transmitted by the wireless access points 130 respectively, and sending the signals to the CPU 142. The CPU 142 is electrically connected to the receiver 141, so as to operate and process the first and second detecting signals to generate the positioning information through the positioning mode built in the CPU 142. The positioning mode of the CPU 142 can be one of Time of Arrival (TOA) positioning technique, Time Difference of Arrival (TDOA) positioning technique, and Received Signal Strength (RSS) positioning technique. Among them, the TOA positioning technique determines the distance and positions the object under detection based on the transmission time of a signal, the TDOA positioning technique realizes the positioning according to a time difference of signal transmission on the basis of a hyperbolic principle, and the RSS positioning technique determines the distance of the object under detection and relevant positioning information according to the strength attenuation of a signal.

The first and second sensing signals and the first and second detecting signals are basically RF signals, and the frequency of the signals is between approximately 2 GHz and 3 GHz. Through the high frequency mode, it is guaranteed that the signal transmission will not be blocked or absorbed by the shielding or other objects in the environment, and the positioning effect will not be influenced.

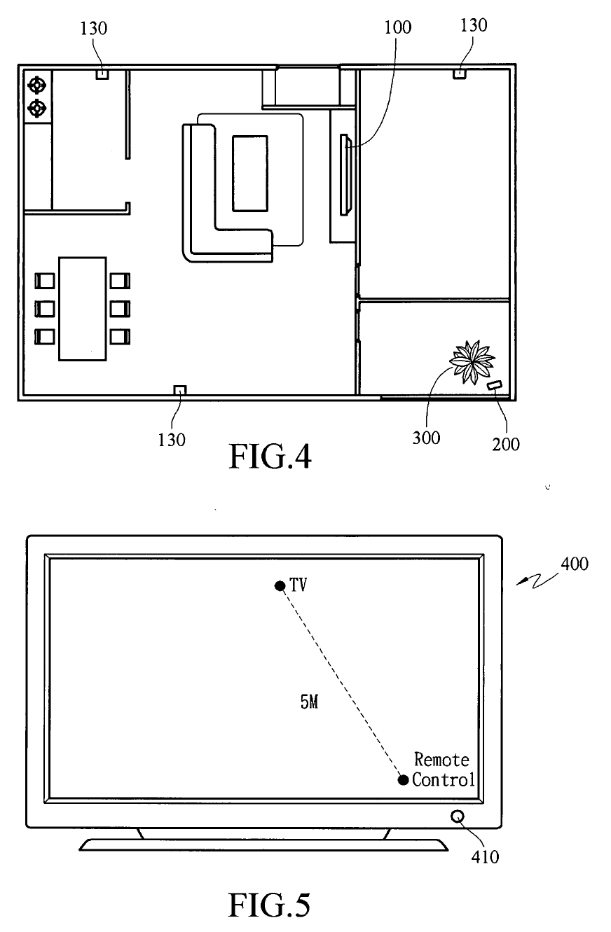

FIGS. 4 and 5 show an implementation aspect of the first embodiment of the remote control positioning system according to the present invention and a picture displayed on the display screen of this implementation aspect respectively.

As shown in FIG. 4, three wireless access points 130 at non-collinear positions, including a top left position, a top right position and a lower central position, are arranged in an indoor environment. Furthermore, additional wireless access points 130 can be arranged according to the area and the shielding condition in the indoor environment. Thus, it is ensured that the area that the wireless access points 130 receive and transmit the RF covers the entire indoor environment, so as to facilitate the transmission of the RF signals. When the user misplaces the remote control 200, and needs to search for the remote control 200 but fails to find it, the user can press the key 410 on the display 100 to start the transmitter 111 to transmit the first sensing signal. The first sensing signal is transmitted to the wireless access points 130 and the wireless transceiving module 120 on the remote control 200. Once the first sensing signal is received, the wireless access points 130 transmits the first detecting signal to the signal processing module 140 on an end of the display 100. The first detecting signal records the duration that the wireless access points 130 receive the first sensing signal and the signal strength. Upon receiving the first sensing signal, the wireless transceiving module 120 on the remote control 200 is induced to transmit the second sensing signal to the wireless access points 130. Similarly, upon receiving the second sensing signal, the wireless access points 130 transmit the second detecting signal to the signal processing module 140 on the end of the display 100. The second detecting signal records the duration that the wireless access points 130 receive the second sensing signal and the signal strength. Finally, the signal processing module 140 operates and generates the relevant positioning information through the positioning mode according to the received first and second detecting signals. The positioning information is displayed on a predetermined channel, so as to display a display picture 400 as shown in FIG. 5. The display picture 400 shows the relevant positioning information of the remote control 200 with the position of the display 100 as a reference position. The positioning information includes the relative distance and relative position relation between the display 100 and the remote control 200. For example, in this embodiment, the distance between the display 100 and the remote control 200 is 5 m, and the remote control 200 is placed to the lower right of the display 100. Thus, the user can easily find the remote control 200 according to the relative position and the relative distance relation shown in the display picture 400.

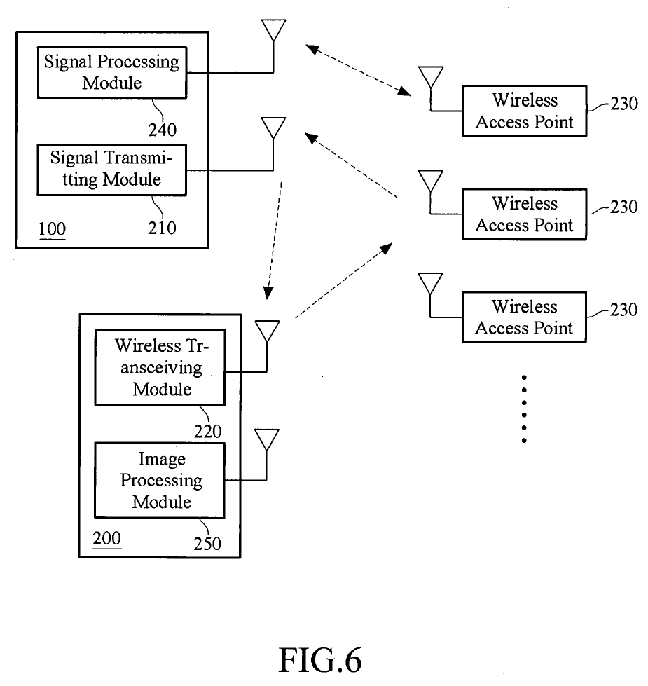

FIG. 6 is a simplified block diagram of the remote control positioning system according to the second embodiment of the present invention.

As shown in FIG. 6, the remote control positioning system of the present invention includes a signal transmitting module 210, an image capturing module 250, a wireless transceiving module 226, at least three wireless access points 230, and a signal processing module 240.

The signal transmitting module 210 is electrically connected to the display 100 for transmitting a first sensing signal to the wireless transceiving module 220 and the wireless access points 230. The signal transmitting module 210 also includes a transmitter 111 and a starting module 112 shown in FIG. 2. The transmitter 111 is used for transmitting the first sensing signal, and the starting module 112 is electrically connected to the transmitter 111, and serves as a touch switch of the transmitter 111. The starting module 112 can be a key module (a key 410 as shown in FIG. 5) or a touch panel (not shown) installed on the display 100, and provides a trigger function of positioning and searching when a user is searching for the remote control 200.

The image capturing module 250 is installed on the remote control 200 for retrieving an external image and converting the external image into a wireless data signal.

The wireless transceiving module 220 is installed on the remote control 200 for starting the image capturing module 250 after the first sensing signal transmitted by the signal transmitting module 210 is received, and then sending a second sensing signal to the wireless access points 230 and sending the wireless data signal recording the external image to the signal processing module 240.

The wireless access points 230 are arranged at different non-collinear positions in an indoor environment, for transmitting a first detecting signal to the signal processing module 240 after the first sensing signal transmitted by the signal transmitting module 210 is received, and transmitting a second detecting signal to the signal processing module 240 after the second sensing signal transmitted by the wireless transceiving module 220 is received. Here, at least three wireless access points 130 are required for providing effective positioning operation on the basis of triangulation principle.

The signal processing module 240 is electrically connected to the display 100, for receiving the first and second detecting signals transmitted from the wireless access points 230 and the wireless data signal transmitted by the wireless transceiving module 220, and operating and generating the positioning information through a positioning mode. The signal processing module 240 can be a functional block built in the display 100 or an external electronic device. Furthermore, the signal processing module 240 also includes a receiver 141 and a CPU 142 shown in FIG. 3. The receiver 141 is used for receiving the first and second detecting signals transmitted by the wireless access points 230 respectively and the wireless data signal transmitted by the wireless transceiving module 220, and sending the signals to the CPU 142. The CPU 142 is electrically connected to the receiver 141, so as to operate and process the first and second detecting signals and the wireless data signal to generate the positioning information through the positioning mode built in the CPU 142. The positioning mode of the CPU 142 can be one of Time of Arrival (TOA) positioning technique, Time Difference of Arrival (TDOA) positioning technique, and Received Signal Strength (RSS) positioning technique. These positioning techniques are the same as those described above, and will not be described herein again.

The first and second sensing signals and the first and second detecting signals are basically RF signals, and the frequency of the signals is between approximately 2 GHz and 3 GHz.

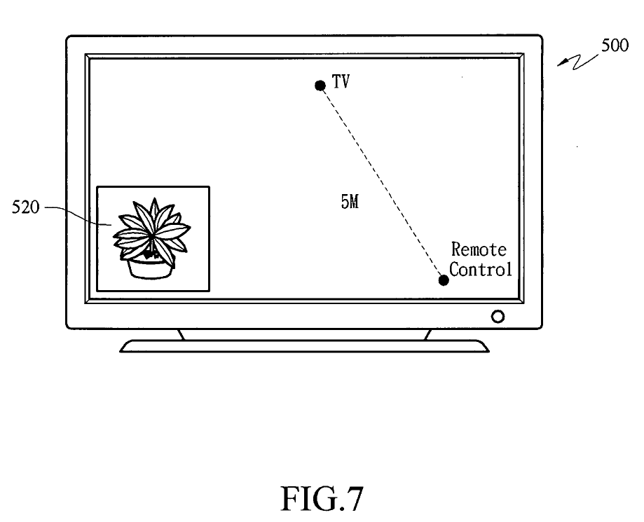

FIG. 7 shows the picture displayed on the display screen of this embodiment. This embodiment has an arrangement aspect similar to that of FIG. 4, and the positioning principle is also similar to the first embodiment. However, the most important difference is that in addition to the relative distance and relative position relation between the display 100 and the remote control 200, the positioning information displayed in the display picture 500 further includes an external environment image captured by the image capturing module 250 on the remote control 200. For example, in FIG. 4, a flower pot 300 is located near the remote control 200. Therefore, the image of the flower pot 300 can be displayed in the display picture 500 at any position e.g., the lower left corner in FIG. 7 by means of a sub-picture 520. Thus, the user can have a deeper impression when determining the relative position, so as to further reduce the time spent on searching for the position of the remote control 200.

By the use of the remote control positioning system of the present invention, when the user is searching for the remote control, the position of the remote control can be determined precisely. Moreover, the remote control positioning system will not become ineffective as limited by the shielding in the environment, so the time that the user spends on searching for the remote control is reduced. In addition to obtaining detailed position information of the remote control on the TV screen, by displaying the sub-picture of the environment image, the user can have a deeper impression when determining the position of the remote control. Thus, the user can rapidly find the remote control to use, and various remote controls can be real-time monitored.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A remote control positioning system, comprising:
a signal transmitting module, electrically connected to a display, for transmitting a first sensing signal;
a wireless transceiving module, installed on a remote control, for transmitting a second sensing signal after receiving the first sensing signal;
at least three wireless access points, arranged at different non-collinear positions, wherein the wireless access points transmit a first detecting signal and a second detecting signal after receiving the first sensing signal and the second sensing signal, respectively; and
a signal processing module, electrically connected to the display, for receiving the first and the second detecting signals and generating a positioning information.

2. The remote control positioning system as claimed in claim 1, wherein the signal transmitting module comprises:
a transmitter, for transmitting the first sensing signal; and
a starting module, electrically connected to the transmitter, for starting the transmitter.

3. The remote control positioning system as claimed in claim 2, wherein the starting module is a key module or a touch panel.

4. The remote control positioning system as claimed in claim 1, wherein the signal processing module comprises:
a receiver, for receiving the first and the second detecting signals; and
a CPU, electrically connected to the receiver, for operating and processing the first and the second detecting signals to generate the positioning information through a positioning mode.

5. The remote control positioning system as claimed in claim 4, wherein the positioning mode is one of a Time of Arrival (TOA) positioning technique, a Time Difference of Arrival (TDOA) positioning technique, and a Received Signal Strength (RSS) positioning technique.

6. The remote control positioning system as claimed in claim 1, wherein the positioning information includes relative distance and relative position relation.

7. The remote control positioning system as claimed in claim 6, wherein the positioning information defines the relative distance and the relative position relation according to a reference position.

8. The remote control positioning system as claimed in claim 7, wherein the reference position is a position of the display.

9. The remote control positioning system as claimed in claim 1, wherein the first and the second sensing signals and the first and the second detecting signals are a radio frequency (RF) signal.

10. The remote control positioning system as claimed in claim 9, wherein a frequency of the RF signal is in a range of 2 GHz to 3 GHz.

11. A remote control positioning system, comprising:
a signal transmitting module, electrically connected to a display, for transmitting a first sensing signal;
an image capturing module, installed on a remote control, for capturing an external image and converting the external image into a wireless data signal;
a wireless transceiving module, electrically connected to the image capturing module, for starting the image capturing module after receiving the first sensing signal, and transmitting a second sensing signal and the wireless data signal;
at least three wireless access points, arranged at different non-collinear positions, wherein the wireless access points transmit a first detecting signal and a second detecting signal after receiving the first sensing signal and the second sensing signal, respectively; and
a signal processing module, electrically connected to the display, for receiving the wireless data signal and the first and the second the detecting signals and generating a positioning information.

12. The remote control positioning system as claimed in claim 11, wherein the signal transmitting module comprises:
a transmitter, for transmitting the first sensing signal; and
a starting module, electrically connected to the transmitter, for starting the transmitter.

13. The remote control positioning system as claimed in claim 12, wherein the starting module is a key module or a touch panel.

14. The remote control positioning system as claimed in claim 11, wherein the signal processing module comprises:
a receiver, for receiving the first and the second detecting signals; and
a CPU, electrically connected to the receiver, for operating and processing the wireless data signal and the first and the second detecting signals to generate the positioning information through a positioning mode.

15. The remote control positioning system as claimed in claim 14, wherein the positioning mode is one of a Time of Arrival (TOA) positioning technique, a Time Difference of Arrival (TDOA) positioning technique, and a Received Signal Strength (RSS) positioning technique.

16. The remote control positioning system as claimed in claim 11, wherein the positioning information includes relative distance, relative position relation, and an external environment image of the remote control.

17. The remote control positioning system as claimed in claim 16, wherein the positioning information defines the relative distance and the relative position relation according to a reference position.

18. The remote control positioning system as claimed in claim 17, wherein the reference position is a position of the display.

19. The remote control positioning system as claimed in claim 11, wherein the first and the second sensing signals and the first and the second detecting signals are a radio frequency (RF) signal range of 2 GHz to 3 GHz.

20. The remote control positioning system as claimed in claim 16, wherein the external environment image is displayed in the display by means of a sub-picture.
